(19) United States
(12) Patent Application Publication
(10) Pub. No.: US 2016/0349956 A1
(43) Pub. Date: Dec. 1, 2016

(54) ELECTRONIC DEVICE AND METHOD FOR CONTROLLING DISPLAY INTERFACE

(71) Applicant: FIH (HONG KONG) LIMITED, Kowloon (HK)

(72) Inventor: WANG-HUNG YEH, New Taipei (TW)

(21) Appl. No.: 14/823,446

(22) Filed: Aug. 11, 2015

(30) Foreign Application Priority Data
May 28, 2015 (CN) 201510281266.2

(51) Int. Cl. G06F 3/0488; G06F 3/0484

(52) U.S. Cl. CPC G06F 3/0488; G06F 3/04847

(57) ABSTRACT

An electronic device includes a touch screen, a processor, and a storage. The storage stores one or more programs executed by the processor, the one or more programs includes a display controlling module, an identifying module, and an executing module. The display controlling module controls the touch screen to form a display region and two touch regions symmetrically disposed on two sides of the display region. The display region displays a plurality of human-computer interfaces corresponding to different applications, the two touch regions detect different touch operations. The identifying module identifies sliding operations applied on the two touch regions. The executing module executes different operations and adjust display contents in the display region according to the sliding operations.

### CROSS-REFERENCE TO RELATED APPLICATIONS

This application claims priority to Chinese Patent Application No. 201510281266.2 filed on May 28, 2015, the contents of which are incorporated by reference herein.

### FIELD

The subject matter herein generally relates to an electronic device and a method for controlling display interfaces displayed on a touch screen of the electronic device.

### BACKGROUND

Watches and other wearable devices have begun to offer functions beyond simple display of the time. For example, some watches have incorporated touch screens and offer the ability to receive touch operations of the user.

### BRIEF DESCRIPTION OF THE DRAWINGS

Implementations of the present technology will now be described, by way of example only, with reference to the attached figures.

FIG. 1 illustrates an isometric view of an electronic device, according to an exemplary embodiment.

FIG. 2 illustrates a block diagram of the electronic device of FIG. 1.

FIG. 3 illustrates a diagrammatic view of a zooming in/out operation applied on a touch screen of the electronic device of FIG. 1.

FIG. 4 illustrates a diagrammatic view of the electronic device of FIG. 1, while the electronic device executes a first application.

FIG. 5 illustrates a diagrammatic view of the electronic device of FIG. 1, while the electronic device executes a second application.

FIG. 6 illustrates a flowchart of a method for controlling display interface of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “module” refers to logic embodied in computing or firmware, or to a collection of software instructions, written in a programming language, such as, Java, C, or assembly. One or more software instructions in the modules can be embedded in firmware, such as in an erasable programmable read only memory (EPROM). The modules described herein can be implemented as either software and/or computing modules and can be stored in any type of non-transitory computer-readable medium or other storage device. Some non-limiting examples of non-transitory computer-readable media include CDs, DVDs, BLU-RAY™, flash memory, and hard disk drives. The term “comprising”, when utilized, means “including, but not necessarily limited to”; it specifically indicates open-ended inclusion or membership in the so-described combination, group, series and the like.

The present disclosure is described in relation to an electronic device and a method for controlling display interfaces displayed on a touch screen of the electronic device.

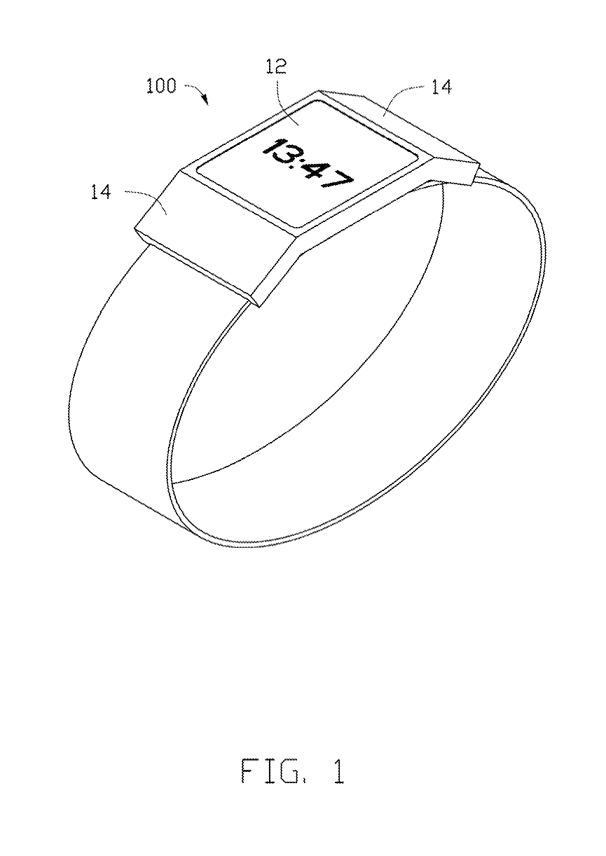

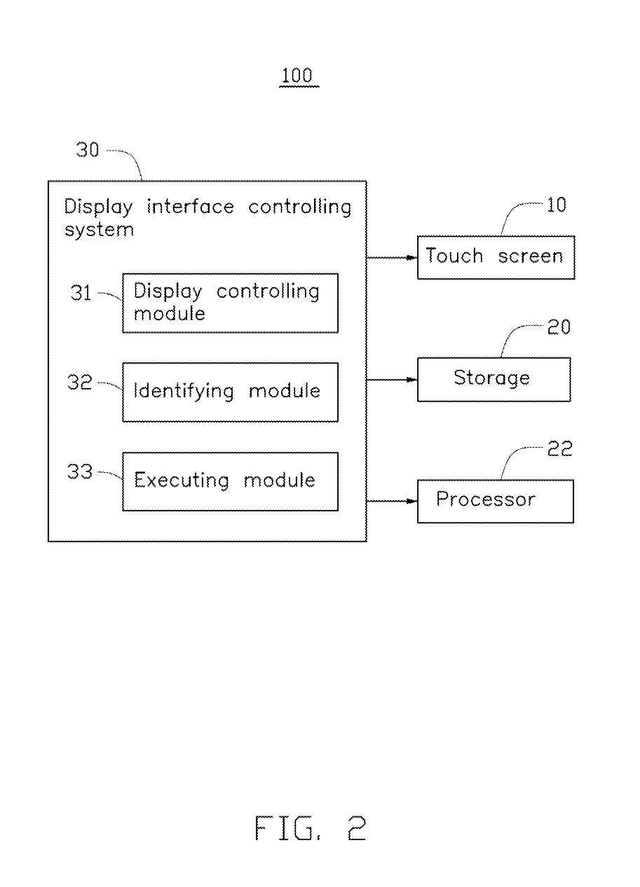

FIG. 1 illustrates an isometric view of an example embodiment of an electronic device 100. In at least one embodiment as shown in FIG. 1, the electronic device 100 can be a cell phone, a smart watch, a smartband, a personal digital assistant, a tablet computer, or any other computing device. Referring to FIG. 2. further, the electronic device 100 can include, but is not limited to, a touch screen 10, a storage 20, a processor 22, and a display interface controlling system 30. FIG. 1 illustrates only one example of the electronic device 100, other examples can comprise more or fewer components than those shown in the embodiment, or have a different configuration of the various components.

The touch screen 10 can be a resistance touch screen, a capacitance touch screen, an optical touch screen, or an infrared touch screen. Referring to FIG. 2. the touch screen 10 includes a display region 12 and two touch regions 14 symmetrically disposed on two sides of the display region 12. The display region 12 is configured to display a plurality of human-computer interfaces corresponding to different applications and detect different touch operations, such as single touch operations, multi-touch operations, or sliding operations. The touch region 14 is configured to detect different touch operations and can be in a dark status when no touch operations are applied on the touch region 14. In at least one embodiment, the display region 12 and the two touch regions 14 physically separate from each other. In other embodiments, the display region 12 and the two touch regions 14 are different areas of a common touch screen, and the display region 12 cannot detect the touch operations.

The processor 22 executes one or more computerized codes and other applications of the electronic device 100 to provide functions of the electronic device 100. The storage 20 can be a non-transitory computer-readable medium and can be an internal storage device, such as a random access memory (RAM) for temporary storage of information, and/or a read only memory (ROM) for permanent storage of information. The storage 20 can also be an external storage device, such as an external hard disk, a storage card, or a data storage medium. The storage 20 pre-stores a plurality of sliding directions and a plurality of applications corresponding to the plurality of sliding directions. Optionally, each of the plurality of applications has a human-computer interface displayed on the touch screen 10. In at least one embodiment, the plurality of sliding directions include a first sliding direction and a second sliding direction. The plurality of applications include a first application corresponding to the first sliding direction and a second application corresponding to the second sliding direction. The first sliding direction can be in a horizontal direction, and the second sliding direction can be in a vertical direction. The first application can be a weather forecast program, and the second application can be an instant messaging program. In other embodiment, the plurality of sliding directions further include a clockwise direction and a counterclockwise direction, and the plurality of applications further include a health management program.

In at least one embodiment, the display interface controlling system 30 can include, but is not limited to, a display controlling module 31, an identifying module 32, and an executing module 33. The above mentioned modules 31-33 can include computerized instructions in the form of one or more computer-readable programs that can be stored in a non-transitory computer-readable medium, such as the storage 20, and be executed by the processor 22 of the electronic device 100.

The display controlling module 31 is configured to control the touch screen 10 to form the display region 12 and the two touch regions 14. In detail, if the display region 12 and the two touch regions 14 physically separate from each other, the display controlling module 31 outputs a first command to actuate the display region 12 and the two touch regions 14. If the display region 12 and the two touch regions 14 are different areas of the touch screen 10, the display controlling module 31 sends a second command to the touch screen 10 to actuate the display region 12 and the two touch regions 14.

The identifying module 32 is configured to identify sliding operations applied on the touch screen 10. The executing module 33 is configured to execute different operations and adjust display contents in the display region 12 according to the sliding operations identified by the identifying module 32. Detailed description will be illustrated below.

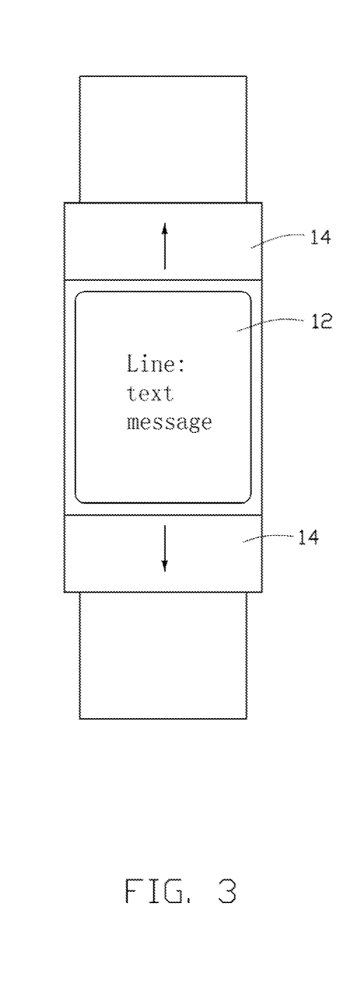

Referring to FIG. 3, if two sliding operations in reverse direction (away from each other) are respectively applied on the two touch regions 14, the identifying module 32 detects the two sliding operations in reverse direction, and the executing module 33 controls a display surface displayed on the display region 12 to zoom in. If two sliding operations in forward direction (toward each other) are respectively applied on the two touch regions 14, the identifying module 32 detects the two sliding operations in forward direction, and the executing module 33 controls a display surface displayed on the display region 12 to zoom out.

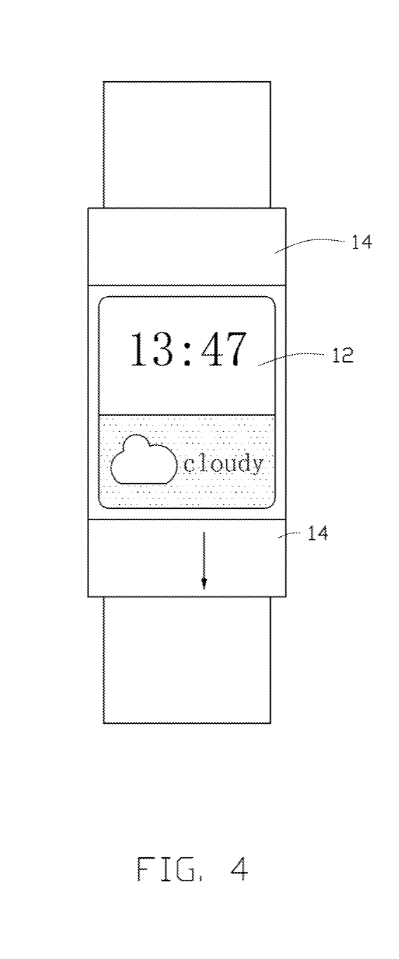

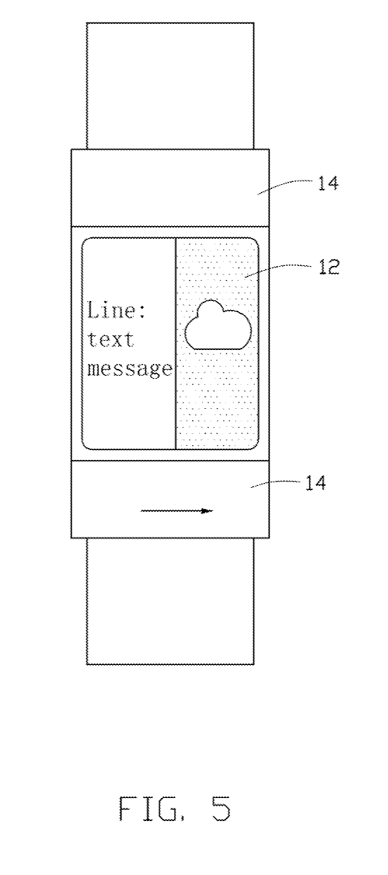

If a sliding operation is applied on one of the touch regions 14, the identifying module 32 detects the sliding operation, and the executing module 33 executes one of the plurality of applications stored in the storage 20 and controls the display region 12 to display a human-computer interface. Referring to FIG. 4 and FIG. 5, if the sliding operation is in a horizontal direction, the executing module 33 executes a first application and controls the display region 12 to display a first human-computer interface associated with the first application. If the sliding operation is in a vertical direction, the executing module 33 executes a second application and controls the display region 12 to display a second human-computer interface associated with the second application.

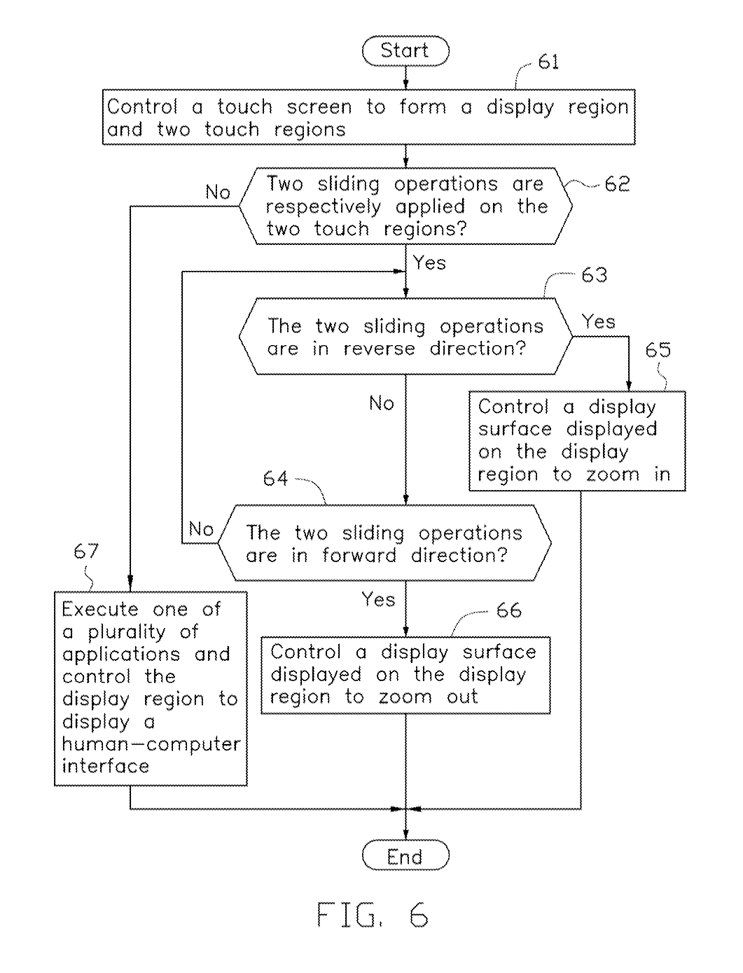

FIG. 6 illustrates a flowchart of a method for controlling display surfaces displayed on the touch screen 10 of the electronic device 100 of FIG. 1. The method is provided by way of example, as there are a variety of ways to carry out the method. Each block shown in FIG. 6 represents one or more processes, methods, or subroutines which are carried out in the example method. Furthermore, the order of blocks is illustrative only and the order of the blocks can change. Additional blocks can be added or fewer blocks may be utilized without departing from the scope of this disclosure. The example method can begin at block 61.

At block 61, the display controlling module controls the touch screen to form the display region and the two touch regions symmetrically disposed on two sides of the display region.

At block 62, the identifying module determines whether the two sliding operations are respectively applied on the two touch regions. If the two first sliding operations are respectively applied on the two touch regions, block 63 is implemented; if only one sliding operation is applied on the one of the touch regions, block 67 is implemented.

At block 63, the identifying module determines whether the two sliding operations are in reverse direction. If the two sliding operations are in reverse direction, block 65 is implemented; if two sliding operations are not in reverse direction, block 64 is implemented.

At block 64, the identifying module determines whether the two sliding operations are in forward direction. If the two sliding operations are in forward direction, block 66 is implemented; if two sliding operations are not in forward direction, block 63 is implemented.

At block 65, the executing module controls the display surface displayed on the display region to zoom in.

At block 66, the executing module controls the display surface displayed on the display region to zoom out.

At block 67, the executing module executes one of the plurality of applications stored in the storage and controls the display region to display the human-computer interface. If the sliding operation is in a horizontal direction, the executing module executes the first application and controls the display region to display the first human-computer interface related to the first application. If the sliding operation is in a vertical direction, the executing module executes the second application and controls the display region to display the second human-computer interface related to the second application.

In summary, the display interface controlling system 30 of the electronic device 100 can selectively change the display interface displayed on the touch screen 10 according different touch operations, thereby satisfying different user requirements.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device comprising:
a touch screen;
a processor coupled to the touch screen; and
a storage coupled to the processor and configured to store one or more programs executed by the processor, the one or more programs causing the processor to:
control the touch screen to form a display region and two touch regions symmetrically disposed on two sides of the display region; wherein the display region is configured to display a plurality of human-computer interfaces corresponding to different applications, the two touch regions are configured to detect different touch operations comprising sliding operations;
identify the sliding operations applied on the two touch regions; and
execute different operations and adjust display contents in the display region according to the sliding operations.

2. The electronic device according to claim 1, wherein if two sliding operations in reverse direction are respectively applied on the two touch regions, the one or more programs causing the processor to control a display surface displayed on the display region to zoom in.

3. The electronic device according to claim 1, wherein if two sliding operations in forward direction are respectively applied on the two touch regions, the one or more programs causing the processor to control a display surface displayed on the display region to zoom out.

4. The electronic device according to claim 1, wherein if a sliding operation is applied on one of the touch regions, the one or more programs causing the processor to execute the different applications and control the display region to display a human-computer interface.

5. The electronic device according to claim 4, wherein if the sliding operation is in a horizontal direction, the one or more programs causing the processor to execute a first application and control the display region to display a first human-computer interface associated with the first application.

6. The electronic device according to claim 4, wherein if the sliding operation is in a vertical direction, the one or more programs causing the processor to execute a second application and control the display region to display a second human-computer interface associated with the second application.

7. A method for controlling display interface of an electronic device having a touch screen, the method comprising:
controlling the touch screen to form a display region and two touch regions symmetrically disposed on two sides of the display region; wherein the display region is configured to display a plurality of human-computer interfaces corresponding to different applications, the two touch regions are configured to detect different touch operations;
identifying sliding operations applied on the two touch regions; and
executing different operations and adjusting display contents in the display region according to the sliding operations.

8. The method according to claim 7, further comprising controlling a display surface displayed on the display region to zoom in if two sliding operations in reverse direction are respectively applied on the two touch regions.

9. The method according to claim 7, further comprising controlling a display surface displayed on the display region to zoom out if two sliding operations in forward direction are respectively applied on the two touch regions.

10. The method according to claim 7, further comprising executing the different applications and controlling the display region to display a human-computer interface if a sliding operation is applied on one of the touch regions.

11. The method according to claim 10, further comprising executing a first application and controlling the display region to display a first human-computer interface associated with the first application if the sliding operation is in a horizontal direction.

12. The method according to claim 10, further comprising executing a second application and controlling the display region to display a second human-computer interface associated with the second application if the sliding operation is in a vertical direction.

13. A method for controlling display of an interface, the method comprising:
displaying a display region and two touch regions separate from the display region and symmetrically disposed on two sides of the display region;
displaying first content in the display region;
identifying sliding operations on at least one of the two touch regions;
changing content displayed in the display region, as follows:
in response to swiping motions away from each other on both of the touch regions, a zoomed out version of the first content;
in response to swiping motions toward each other on both of the touch regions, a zoomed in version of the first content;
in response to a swiping motion on one of the touch regions and not the other of the touch regions, replacing the first content with second content, the second content being based on the first content and the direction of the swiping motion.
